(19) United States
(12) Patent Application Publication
(10) Pub. No.: US 2025/0354020 A1
(43) Pub. Date: Nov. 20, 2025

(54) Conductive Paste Based on Seed Silver Powder and Preparation Method

(71) Applicant: Jiangsu Riyu Photovoltaic New Material Technology Co., Ltd., Wuxi (CN)

(72) Inventors: Jing ZHENG, Wuxi (CN); Li YAN, Wuxi (CN); Wanting WEI, Wuxi (CN); Weikang HUA, Wuxi (CN)

(21) Appl. No.: 19/284,747

(22) Filed: Jul. 30, 2025

(30) Foreign Application Priority Data
Oct. 30, 2024 (CN) 2024115250427

(51) Int. Cl. C09D 5/24; C09D 1/00; C09D 4/00

(52) U.S. Cl. CPC C09D 5/24; C09D 1/00; C09D 4/00

(57) ABSTRACT

The present disclosure relates to a conductive paste based on seed silver powder and a preparation method therefor, belonging to the technical field of photovoltaic cells. The conductive paste includes 10-85 wt % seed silver powder, 2-5 wt % glass frit, and 8-12 wt % organic vehicle, with the balance being spherical silver powder. The seed silver powder uses base metal powder as a matrix. Silver is grown on the surface of the matrix via liquid-phase reduction using a supported agent. After calcination, multiple silver pores are formed in the surface of the base metal powder. After photoinduced silver electroplating, “silver anchors” are formed interspersed in the sintered layer. This increases the contact area between the sintered layer and the electroplated layer, reduces the resistivity of the grid electrode, enhances the interlayer bonding strength, mitigates resistance increase, effectively improves the photoelectric conversion efficiency, and reduces the cost of the conductive paste.

### TECHNICAL FIELD

The present disclosure belongs to the technical field of photovoltaic cells, and specifically relates to a conductive paste based on seed silver powder and a preparation method therefor.

### BACKGROUND

Photovoltaic power generation, as a method to directly convert solar energy into electric energy, has the advantages of being environmentally friendly and renewable, and is one of the important directions for developing green and clean energy. Conductive paste is a key material in photovoltaic cell production and primarily used to fabricate front and back grid electrodes of solar cells.

Conventional grid electrodes are formed by directly printing and sintering conductive paste using screen printing technology. This method makes it difficult to improve the aspect ratio of the grid electrodes. Using a seed layer combined with photoinduced electroplating technology can effectively enhance the aspect ratio of the grid electrodes, reduce their resistivity, increase the light-receiving area of the cell, and decrease the amount of silver paste used. This is of positive significance for reducing the cost of photovoltaic cells and improving photoelectric conversion efficiency. However, seed layer conductive pastes mostly use ultrafine silver powder as a matrix, resulting in high costs. Additionally, differences in the microstructural density between the seed layer and the electroplated layer can lead to micro-cracks at the interface during long-term use, especially under large temperature variations. Furthermore, electrochemical effects due to interlayer currents further degrade the bonding performance between layers, consequently increasing the internal resistance of the cell and reducing photoelectric conversion efficiency. Therefore, this application aims to provide a conductive paste applicable to the seed layer.

### SUMMARY

To solve the technical problems mentioned in the background, the objective of the present disclosure is to provide a conductive paste based on seed silver powder and a preparation method therefor.

The objective of the present disclosure can be achieved through the following technical solutions:

A conductive paste based on seed silver powder includes the following components: 10-85 wt % seed silver powder, 2-5 wt % glass frit, and 8-12 wt % organic vehicle, with the balance being spherical silver powder.

The seed silver powder is prepared by the following method:

Step a1: Triallylamine, mercaptoethanol, and ethanol are mixed and heated to 55-65° C. The mixture is stirred at 120-160 rpm for activation for 20-30 min. Subsequently, a photoinitiator is added, and the mixture is subjected to UV irradiation at 200-300 W/m² for reaction for 2.5-3 h. After the reaction, removing ethanol by rotary evaporation to obtain an intermediate.

Further, a usage ratio of the triallylamine, the mercaptoethanol, the photoinitiator, and the ethanol is 0.1 mol:0.3 mol:0.25-0.3 mL:80-100 mL. The photoinitiator is preferably liquid photoinitiator 1173. Triallylamine and mercaptoethanol are heated for activation, followed by a photo-initiated click addition to form a nitrogen-centered thioether compound.

Step a2: The intermediate, sodium methoxide, and tetrahydrofuran are mixed and heated under reflux for 1-1.3 h. Subsequently, a dispersion of trichloroethyl phosphate and triethylamine are added. The reaction was maintained at 60-70° C. with stirring at 60-90 rpm for reaction for 5.5-7 h. After the reaction, low-boiling components are removed by rotary evaporation to obtain a supported agent.

Further, a usage ratio of the intermediate, the trichloroethyl phosphate, the sodium methoxide, the triethylamine, and the tetrahydrofuran is 0.1 mol:70-85 mmol:25-30 mmol:8-12 mL:55-75 mL. The dispersion of trichloroethyl phosphate has a volume fraction of 30-40%. Promoted by sodium methoxide and triethylamine, the intermediate undergoes etherification with trichloroethyl phosphate to form a low-molecular-weight network compound.

Step a3: Base metal micropowder, the supported agent, a nonionic surfactant, and dimethylacetamide are pre-mixed. A silver nitrate solution is then added under stirring for 30-40 min. Nitrogen gas was introduced for protection, followed by the slow addition of a hydrazine hydrate solution under ultrasonic oscillation for reaction for 1.5-2 h. After the reaction, standing for precipitation is allowed, supernatant is decanted and dried to obtain a composite precursor.

Further, a usage ratio of the base metal micropowder, the silver nitrate, the hydrazine hydrate solution, the supported agent, the nonionic surfactant, and the dimethylacetamide is 1 g:3.8-14.2 g:0.8-1.1 mL:0.4-0.6 g:0.25-0.3 g:35-50 mL. The silver nitrate solution has a mass fraction of 10%, and the hydrazine hydrate solution has a volume fraction of 40%. The nonionic surfactant is preferably Tween 80. The nitrogen-containing thioether structure in the supported agent molecule forms a stable strong chelation, preferentially chelating with active sites on the surface of the base metal micropowder, thereby attaching the supported agent to the surface of the base metal micropowder. The phosphorus-oxygen structure in the supported agent molecule has weaker chelation and accumulates on the surface of the base metal micropowder to capture silver ions, forming an initial silver ion enrichment layer. Subsequently, during reduction by hydrazine hydrate, elemental silver is grown on the surface with an initial composite as the core.

Further, the base metal micropowder is one of copper powder, nickel powder, and iron powder, with an average particle size not exceeding 1 μm.

Step a4: Under a nitrogen atmosphere, the composite precursor is heated to 550-620° C. and calcined for 1.8-2.4 h. Subsequently, the composite precursor is continued to heat to 880-920° C. and calcined for 1-1.2 h. Product is furnace-cooled to room temperature, ground, and dispersed to obtain seed silver powder. The organic supported agent in the composite precursor is subjected to thermal decomposition, and a silver-attached layer with multiple pores is formed in the surface of the base metal powder.

Preferably, the glass frit has a melting point of 600-700° C. At this melt range, the silver paste is easily sintered densely.

Preferably, an average particle size of the spherical silver powder should not exceed 5 μm, which is beneficial for improving the flatness of the sintered grid electrodes.

A preparation method for a conductive paste based on seed silver powder, including the following steps:
a. preparing seed silver powder according to the above methods; and
b. pre-mixing seed silver powder, glass frit, and spherical silver powder, then adding an organic vehicle and grinding to prepare a paste, and obtaining the conductive paste.

The present disclosure has the beneficial effects:

The present disclosure discloses a preparation method for silver-encapsulated base metal seed silver powder. Through photo-initiated addition reaction between triallylamine and mercaptoethanol, a nitrogen-containing thioether compound, namely intermediate, is formed. Then, under the promotion of sodium methoxide and triethylamine, the intermediate undergoes etherification with trichloroethyl phosphate to form a low-molecular-weight network compound, namely supported agent. Subsequently, in a liquid-phase environment, the supported agent complexes with metal micropowder, and the nitrogen-containing thioether structure in the supported agent molecule forms a stable strong chelation, preferentially chelating with active sites on the surface of the base metal micropowder, thereby attaching the supported agent to the surface of the base metal micropowder. The phosphorus-oxygen structure of the supported agent molecule has weaker chelation and captures subsequently added silver ions, forming an initial silver ion enrichment layer on the surface of the base metal micropowder. Elemental silver is grown on the surface via reduction by hydrazine hydrate, forming a composite precursor. Finally, calcination causes thermal decomposition of the organic supported agent in the composite precursor, forming a silver-attached layer with multiple pores in the surface of the base metal powder. This method has low limitations on the type of base metal, allowing selection of a suitable base metal as the core according to the application requirements of the conductive paste, resulting in high product designability and significantly reducing the applied material cost of the conductive paste. Additionally, the introduction of seed silver powder makes the conductive paste more suitable for photoinduced electroplating technology. The seed silver powder surface contains abundant silver pores, which, after sintering, uniformly introduce microscopic pores into the sintered layer. During electroplating, these pores internally create localized high current density, preferentially depositing silver to form “silver anchors” interspersed in the sintered layer. This increases the contact area between the sintered layer and the electroplated layer, helping to reduce overall resistivity. Besides, this increases the bonding strength between the sintered layer and the electroplated layer, mitigating the decrease in photoelectric conversion efficiency caused by interfacial delamination, and helping to enhance the overall efficiency of photovoltaic modules during their service life.

### DETAILED DESCRIPTION

The technical solutions of the present disclosure will be clearly and completely described below with reference to examples. Obviously, the described examples are only a part of the examples of the present disclosure, not all of them. Based on the examples in the present disclosure, all other examples obtained by those of ordinary skill in the art without creative efforts shall fall within the protection scope of the present disclosure.

The GT45-type glass frit mentioned in the present disclosure includes, by mass percentage: 10%- 30% of aluminosilicate, 5%- 15% of calcium carbonate, 1%- 5% of sodium oxide, 30%- 45% of borate, and 1%- 5% of alkaline earth metal.

The FD66A-type glass frit mentioned in the present disclosure includes, by weight percentage: 10%- 30% of borate, 10%- 25% of silicate, 50%- 70% of bismuth oxide, and 1%- 10% of calcium carbonate.

### Example 1

The specific implementation process for preparation of conductive paste based on seed silver powder is as follows:

### (a) Preparation of Seed Silver Powder

Step a1: Triallylamine, mercaptoethanol, and ethanol were mixed and heated to 65° C. The mixture was stirred at 160 rpm for activation for 20 min. Subsequently, a photoinitiator was added, and the mixture was subjected to UV irradiation at 300 W/m² for reaction for 2.5 h. A usage ratio of the triallylamine, the mercaptoethanol, the photoinitiator, and the ethanol was 0.1 mol:0.3 mol:0.3 mL:100 mL. The photoinitiator is commercially available photoinitiator 1173 (2-Hydroxy-2-methyl-1-phenyl-1-propanone). Upon reaction completion, ethanol was removed by rotary evaporation to obtain an intermediate.

Step a2: The intermediate, sodium methoxide, and tetrahydrofuran were mixed and

heated under reflux for 1 h. Subsequently, a dispersion of trichloroethyl phosphate and triethylamine were added. The reaction was maintained at 70° C. with stirring at 90 rpm for 5.5 h. A usage ratio of the intermediate, the trichloroethyl phosphate, the sodium methoxide, the triethylamine, and the tetrahydrofuran was 0.1 mol:85 mmol:30 mmol:12 mL:75 mL. The dispersion of trichloroethyl phosphate employed carbon tetrachloride as a dispersion solvent, with a volume fraction of 40% for trichloroethyl phosphate. After the reaction, low-boiling components primarily including carbon tetrachloride and tetrahydrofuran were removed by rotary evaporation to obtain a supported agent.

Step a3: Base metal micropowder, the supported agent, a nonionic surfactant, and dimethylacetamide were pre-mixed. A silver nitrate solution was then added under stirring for 30 minutes. Nitrogen gas was introduced for protection, followed by the slow addition of a hydrazine hydrate solution under 20 kHz ultrasonic oscillation for reaction for 1.5 h. The base metal micropowder was Brofos-Fe-800 iron powder with an average particle size of 800 nm. The nonionic surfactant was commercially available Tween 80. The silver nitrate solution had a mass fraction of 10%. The hydrazine hydrate solution was a 40 vol % industrial-grade material. A usage ratio of the base metal micropowder, the silver nitrate, the hydrazine hydrate solution, the supported agent, the nonionic surfactant, and the dimethylacetamide was 1 g:3.8 g:1.1 mL:0.6 g:0.3 g:50 mL. After reaction completion, the mixture was allowed to stand for precipitation. Supernatant was decanted, and solid residue was dried to obtain a composite precursor.

Step a4: The composite precursor was placed in a nitrogen-atmosphere furnace

preheated to 300° C. The temperature was raised to 620° C. for calcination over 1.8 h, and then further increased to 920° C. for calcination over 1.2 h. Product was furnace-cooled to room temperature, ground, and dispersed to obtain seed silver powder.

### (b) Preparation of Conductive Paste

Formulation: Raw materials were weighed by weight percentage: 10 wt % seed silver

powder (prepared in this example); 2 wt % glass frit (GT45-type with a melting point of 635° C.); 8 wt % organic vehicle (formulated from dibutyl phthalate, ethyl cellulose, xylene, and terpineol at a mass ratio of 1:0.15:0.8:0.5); and 80 wt % spherical silver powder (Brofos-Ag—W03 with an average particle size of 3 μm).

Paste Production: The seed silver powder, the glass frit, and the spherical silver powder were blended in a high-speed mixer at 1000 rpm for 10 min. The organic vehicle was then added, and the mixture underwent circulation grinding in a mill for 15 min. Conductive paste was discharged after grinding.

### Example 2

The specific implementation process for preparation of conductive paste based on seed silver powder is as follows:

### (a) Preparation of Seed Silver Powder

Step a1: Triallylamine, mercaptoethanol, and ethanol were mixed and heated to 55° C.

The mixture was stirred at 120 rpm for activation for 30 min. Subsequently, a photoinitiator was added, and the mixture was subjected to UV irradiation at 200 W/m² for reaction for 3 h. A usage ratio of the triallylamine, the mercaptoethanol, the photoinitiator, and the ethanol was 0.1 mol:0.3 mol:0.25 mL:80 mL. The photoinitiator is commercially available photoinitiator 1173. Upon reaction completion, ethanol was removed by rotary evaporation to obtain an intermediate.

Step a2: The intermediate, sodium methoxide, and tetrahydrofuran were mixed and heated under reflux for 1.3 h. Subsequently, a dispersion of trichloroethyl phosphate and triethylamine were added. The reaction was maintained at 60° C. with stirring at 60 rpm for 7 h. A usage ratio of the intermediate, the trichloroethyl phosphate, the sodium methoxide, the triethylamine, and the tetrahydrofuran was 0.1 mol:70 mmol:25 mmol:8 mL:55 mL. The dispersion of trichloroethyl phosphate employed carbon tetrachloride as a dispersion solvent, with a volume fraction of 30% for trichloroethyl phosphate. After the reaction, low-boiling components primarily including carbon tetrachloride and tetrahydrofuran were removed by rotary evaporation to obtain a supported agent.

Step a3: Base metal micropowder, the supported agent, a nonionic surfactant, and dimethylacetamide were pre-mixed. A silver nitrate solution was then added under stirring for 40 min. Nitrogen gas was introduced for protection, followed by the slow addition of a hydrazine hydrate solution under 25 kHz ultrasonic oscillation for reaction for 2 h. The base metal micropowder was Brofos-Fe-800 iron powder with an average particle size of 800 nm. The nonionic surfactant was commercially available Tween 80. The silver nitrate solution had a mass fraction of 10%. The hydrazine hydrate solution was a 40 vol % industrial-grade material. A usage ratio of the base metal micropowder, the silver nitrate, the hydrazine hydrate solution, the supported agent, the nonionic surfactant, and the dimethylacetamide was 1 g:14.2 g:0.8 mL:0.4 g:0.253 g:35 mL. After reaction completion, the mixture was allowed to stand for precipitation. Supernatant was decanted, and solid residue was dried to obtain a composite precursor.

Step a4: The composite precursor was placed in a nitrogen-atmosphere furnace preheated to 300° C. The temperature was raised to 550° C. for calcination over 2.4 h, and then further increased to 880° C. for calcination over 1.2 h. Product was furnace-cooled to room temperature, ground, and dispersed to obtain seed silver powder.

### (b) Preparation of Conductive Paste

Formulation: Raw materials were weighed by weight percentage: 55 wt % seed silver powder (prepared in this example); 4 wt % glass frit (GT45-type with a melting point of 635° C.); 12 wt % organic vehicle (formulated from dibutyl phthalate, ethyl cellulose, xylene, and terpineol at a mass ratio of 1:0.12:1.1:0.4); and 29 wt % spherical silver powder (Brofos-Ag—W03).

Paste Production: The seed silver powder, the glass frit, and the spherical silver powder were blended in a high-speed mixer at 1000 rpm for 10 min. The organic vehicle was then added, and the mixture underwent circulation grinding in a mill for 15 min. Conductive paste was discharged after grinding.

### Example 3

The specific implementation process for preparation of conductive paste based on seed silver powder is as follows:

### (a) Preparation of Seed Silver Powder

Step a1: Triallylamine, mercaptoethanol, and ethanol were mixed and heated to 60° C.

The mixture was stirred at 160 rpm for activation for 30 min. Subsequently, a photoinitiator was added, and the mixture was subjected to UV irradiation at 240 W/m² for reaction for 2.8 h. A usage ratio of the triallylamine, the mercaptoethanol, the photoinitiator, and the ethanol was 0.1 mol:0.3 mol:0.28 mL:90 mL. The photoinitiator is commercially available photoinitiator 1173. Upon reaction completion, ethanol was removed by rotary evaporation to obtain an intermediate.

Step a2: The intermediate, sodium methoxide, and tetrahydrofuran were mixed and heated under reflux for 1.2 h. Subsequently, a dispersion of trichloroethyl phosphate and triethylamine were added. The reaction was maintained at 70° C. with stirring at 90 rpm for 6.5 h. A usage ratio of the intermediate, the trichloroethyl phosphate, the sodium methoxide, the triethylamine, and the tetrahydrofuran was 0.1 mol:75 mmol:30 mmol:10 mL:70 mL. The dispersion of trichloroethyl phosphate employed carbon tetrachloride as a dispersion solvent, with a volume fraction of 30% for trichloroethyl phosphate. After the reaction, low-boiling components primarily including carbon tetrachloride and tetrahydrofuran were removed by rotary evaporation to obtain a supported agent.

Step a3: Base metal micropowder, the supported agent, a nonionic surfactant, and dimethylacetamide were pre-mixed. A silver nitrate solution was then added under stirring for 40 min. Nitrogen gas was introduced for protection, followed by the slow addition of a hydrazine hydrate solution under 25 kHz ultrasonic oscillation for reaction for 1.8 h. The base metal micropowder was Brofos-Fe-800 iron powder with an average particle size of 800 nm.

The nonionic surfactant was commercially available Tween 80. The silver nitrate solution had a mass fraction of 10%. The hydrazine hydrate solution was a 40 vol % industrial-grade material. A usage ratio of the base metal micropowder, the silver nitrate, the hydrazine hydrate solution, the supported agent, the nonionic surfactant, and the dimethylacetamide was 1 g:10.5 g:0.9 mL:0.5 g:0.28 g:45 mL. After reaction completion, the mixture was allowed to stand for precipitation. Supernatant was decanted, and solid residue was dried to obtain a composite precursor.

Step a4: The composite precursor was placed in a nitrogen-atmosphere furnace preheated to 300° C. The temperature was raised to 600° C. for calcination over 2.2 h, and then further increased to 920° C. for calcination over 1 h. Product was furnace-cooled to room temperature, ground, and dispersed to obtain seed silver powder.

### (b) Preparation of Conductive Paste

Formulation: Raw materials were weighed by weight percentage: 85 wt % seed silver

powder (prepared in this example); 5 wt % glass frit (FD66A-type with a melting point of 700° C.); and 10 wt % organic vehicle (formulated from dibutyl phthalate, ethyl cellulose, xylene, and terpineol at a mass ratio of 1:0.12:1:0.5).

Paste Production: The seed silver powder and the glass frit were blended in a high-speed mixer at 1000 rpm for 10 min. The organic vehicle was then added, and the mixture underwent circulation grinding in a mill for 15 min. Conductive paste was discharged after grinding.

### Comparative Example 1

In this comparative example, with reference to Example 3, the seed silver powder was replaced with spherical silver powder (Brofos-Ag—W03 type raw material, average particle size: 3 μm). The remaining implementation processes are identical.

### Comparative Example 2

In this comparative example, with reference to Example 3, the seed silver powder was replaced with silver-encapsulated copper micropowder (Brofos-CuAg30-W02 type raw material, morphology: spherical, particle size: 2 μm) in identical weight proportion. The remaining implementation processes are identical.

A 156×156 mm silicon wafers was used as a substrate. The conductive paste prepared above was screen-printed on the wafer surface, sintered, and subjected to photoinduced silver plating to form a cell silicon wafer. Initial resistivity ρ₀ was measured using an SZT-B four-probe tester. The cell silicon wafer was then placed in a thermal chamber and cycled between 0° C. and 70° C. to simulate the actual working temperature, with single cycle duration of 2 h for a total test period of 1,000 h. Subsequently, post-thermal-cycling resistivity ρ₁ was tested. Initial conversion efficiency Eff₀ and post-thermal-cycling conversion efficiency Eff₁ were tested using a Berger tester. Detailed results are shown in Table 1:

TABLE 1

| | | | | Compar- | Compar- |
|---|---|---|---|---|---|
| | | | | ative | ative |
| | Example 1 | Example 2 | Example 3 | Example 1 | Example 2 |
| ρ0/Ω · cm⁻¹ | 3.35 × | 3.82 × | 3.69 × | 3.07 × | 4.12 × |
| | 10⁻⁶ | 10⁻⁶ | 10⁻⁶ | 10⁻⁶ | 10⁻⁶ |
| ρ1/Ω · cm⁻¹ | 3.61 × | 4.19 × | 3.88 × | 3.91 × | 5.39 × |
| | 10⁻⁶ | 10⁻⁶ | 10⁻⁶ | 10⁻⁶ | 10⁻⁶ |
| Eff0/% | 26.61 | 26.54 | 26.57 | 26.69 | 26.24 |
| Eff1/% | 26.29 | 26.14 | 26.30 | 26.14 | 25.59 |

As seen from the test results in Table 1, the initial resistivity of the battery silicon wafers prepared with the conductive paste of the Examples is slightly higher than that of Comparative Example 1, and the initial conversion efficiency is slightly lower than that of Comparative Example 1. However, compared to Comparative Example 2, the initial resistivity is significantly reduced, and the photoelectric conversion efficiency is significantly improved. Further, the decrease in photoelectric conversion efficiency after temperature cycling is smaller, which is beneficial for maintaining the stability of the photovoltaic cell.

In the description of the specification, references to terms such as “one embodiment,” “example,” “specific example,” etc., mean that the specific features, structures, materials, or characteristics described in connection with the embodiment or example are included in at least one embodiment or example of the present disclosure. In this specification, schematic references to the above terms do not necessarily refer to the same embodiment or example. Furthermore, the described specific features, structures, materials, or characteristics may be combined in any suitable manner in any one or more embodiments or examples.

The above content is merely illustrative and explanatory of the present disclosure. Those skilled in the art may make various modifications, supplements, or adopt similar alternatives to the described specific embodiments, as long as they do not deviate from the disclosure or exceed the scope defined by the claims, they should fall within the protection scope of the present disclosure.

What is claimed is:

1. A conductive paste composition, consisting of the following components: 10-85 wt % seed silver powder, 2-5 wt % glass frit, and 8-12 wt % organic vehicle, with the balance being spherical silver powder;
the preparation method of the seed silver powder comprising the following steps:
step a1: mixing triallylamine, mercaptoethanol, and ethanol, heating to 55-65° C., stirring for activation for 20-30 minutes, then adding a photoinitiator and subjecting to UV irradiation at 200-300 W/m² for reaction for 2.5-3 hours, and after the reaction, removing ethanol by rotary evaporation to obtain an intermediate;
step a2: mixing the intermediate, sodium methoxide, and tetrahydrofuran, heating under reflux for 1-1.3 hours, then adding a dispersion of trichloroethyl phosphate and triethylamine, maintaining the temperature at 60-70° C., stirring for reaction for 5.5-7 hours, and after the reaction, removing low-boiling components by rotary evaporation to obtain a supported agent;
step a3: pre-mixing base metal micropowder, the supported agent, a nonionic surfactant, and dimethylacetamide, then adding a silver nitrate solution and stirring for 30-40 minutes, introducing nitrogen gas for protection, slowly adding a hydrazine hydrate solution under ultrasonic oscillation for reaction for 1.5-2 hours, and after the reaction, allowing to stand for precipitation, decanting supernatant, and drying to obtain a composite precursor;
step a4: under a nitrogen atmosphere, heating the composite precursor to 550-620° C. and calcining for 1.8-2.4 hours, then continuing to heat to 880-920° C. and calcining for 1-1.2 hours, furnace cooling to room temperature, and then grinding and dispersing to obtain seed silver powder.

2. The conductive paste composition according to claim 1, wherein in step a2, a usage ratio of the intermediate, the trichloroethyl phosphate, the sodium methoxide, the triethylamine, and the tetrahydrofuran is 0.1 mol:70-85 mmol:25-30 mmol:8-12 mL:55-75 mL.

3. The conductive paste composition according to claim 1, wherein in step a3, a usage ratio of the base metal micropowder, the silver nitrate, the hydrazine hydrate solution, the supported agent, the nonionic surfactant, and the dimethylacetamide is 1 g:3.8-14.2 g:0.8-1.1 mL:0.4-0.6 g:0.25-0.3 g:35-50 mL, and the hydrazine hydrate solution has a volume fraction of 40%.

4. The conductive paste composition according to claim 1, wherein in step a3, the base metal micropowder is one of copper powder, nickel powder, and iron powder, with an average particle size not exceeding 1 μm.

5. The conductive paste composition according to claim 1, wherein in step b, the glass frit has a melting point of 600-700° C.

6. The conductive paste composition according to claim 1, wherein in step b, an average particle size of the spherical silver powder does not exceed 5 μm.

7. The preparation method for the conductive paste composition according to claim 1, comprising pre-mixing the seed silver powder, glass frit, and spherical silver powder, then adding an organic vehicle and grinding to prepare a paste, obtaining a conductive paste.
